(19) United States
(12) Patent Application Publication
(10) Pub. No.: US 2004/0262973 A1
(43) Pub. Date: Dec. 30, 2004

(54) System for locking a first element with a second element, and a seat with such a locking system

(76) Inventors: Yann Reubeuze, Landigou (FR); Francois Baloche, La Carneille (FR)

Correspondence Address: MCCRACKEN & FRANK LLP, 200 W. ADAMS STREET, SUITE 2150, CHICAGO, IL, 60606, US

(21) Appl. No.: 10/874,084

(22) Filed: Jun. 22, 2004

(30) Foreign Application Priority Data
Jun. 24, 2003 (FR) 03 07607

(51) Int. Cl. E05C 5/00

(52) U.S. Cl. 297/378.13

(57) ABSTRACT

A system for locking a first element with a second element, the locking system comprising a plate and/or a latch including at least one deformable zone adapted to deform in the event of one of the first and second elements being subjected to a predetermined impact, so as to cause a portion of the plate and a portion of the latch to move towards each other sufficiently for the portion of the latch to come into abutment contact against the portion of the plate, thereby preventing the latch from pivoting towards the unlocked position.

### FIELD OF THE INVENTION

The present invention relates to a system for locking a first element with a second element, and to a vehicle seat fitted with such a locking system.

More particularly, the invention relates to a locking system comprising:

at least one plate fitted in fixed manner on the first element;

a latch including a notch for co-operating with an anchor member of the second element, the latch being pivotally mounted on the plate about a pivot pin to pivot between a locked position in which the notch co-operates with the anchor member and an unlocked position; and

control means actuatable by a user from a locking position in which said control means hold the latch in the locked position so as to lock together the first and second elements, towards an unlocking position in which said control means enable the latch to pivot about the pivot pin in such a manner as to unlock the first and second elements.

### BACKGROUND OF THE INVENTION

Such prior art locking systems can be used in particular, although not necessarily, to equip vehicle seats, in which, for example, the first element is formed by the seat back while the second element is formed by a fixed portion of the vehicle. In which case, the seat back is mounted to pivot relative to the vehicle body between a raised position for use and a folded-down position.

The main function of such a locking system is then to ensure that the seat back is maintained in the raised position for use in the event of it being subjected to an impact, in particular when baggage placed in the trunk strikes the rear face of the seat back.

Nevertheless, those prior art locking systems do not present sufficient strength to retain the seat back effectively relative to the vehicle when said seat back is subjected to impacts that are relatively large.

### OBJECTS AND SUMMARY OF THE INVENTION

A particular object of the present invention is to mitigate those above-mentioned drawbacks.

To this end, the invention provides a locking system wherein the plate and/or the latch comprises at least one deformable zone adapted to deform following an impact of predetermined magnitude suffered by one of the first and second elements, by causing a portion of the plate to move sufficiently towards a portion of the latch to ensure that said latch portion comes into abutment contact against said plate portion, thereby preventing the latch from pivoting towards the unlocked position.

In preferred embodiments of the invention, recourse may optionally also be made to one or more of the following dispositions:

the plate includes at least one deformable zone situated, when the latch is in the locked position, substantially between the anchor member and a portion for fixing the plate to the first element;

the plate includes at least one deformable zone situated, when said latch is in the locked position, between the anchor member and the pivot pin for the latch;

the latch includes a slot which extends from the bottom of the notch of said latch, said slot being of a width that is narrower than the width of the notch and having a bottom which forms a deformable zone;

the control means comprise a control member actuatable by a user and including a housing, the control member being mounted to be displaceable on the plate in a direction that is substantially rectilinear and perpendicular to the pivot pin of the latch, between firstly a locking position in which a finger of the latch is housed in the housing of said control member to prevent the latch from pivoting while it is in the locked position so as to lock the first element with the second element, and secondly an unlocking position in which said control member is displaced in the rectilinear direction to enable the finger of the latch to be disengaged from the housing of said control member and to enable the latch to pivot about the pivot pin and towards the unlocked position;

the control member which extends substantially vertically presents a window of oblong shape in which the pivot pin of the latch is housed;

the control member and the latch are connected together by an elastically deformable element adapted firstly to bring the control member into the locking position when the latch is in the locked position in which the anchor member prevents the latch from pivoting, and secondly to bring and hold the latch into the unlocked position when it no longer co-operates with the anchor member; and

the notch of the latch presents an edge which extends beyond the opening of said notch to come into co-operation by contact with the locking member of the second element, by causing said latch to pivot from the unlocked position towards the locked position when the first and second elements are moved towards each other.

Furthermore, the invention also provides a motor vehicle seat including a seat back designed to be pivotally mounted relative to the structure of the vehicle between a folded-down position and a raised, in-use position in which said seat back is locked to a fixed portion of the vehicle by means of a locking system as defined above.

### BRIEF DESCRIPTION OF THE DRAWINGS

Other characteristics and advantages of the invention appear from the following description of embodiments thereof given by way of non-limiting example, and with reference to the accompanying drawings.

In the drawings:

FIG. 1 is a diagrammatic side elevation view, partially in section, of a vehicle back seat;

FIG. 2 is a plan view of the back seat shown in FIG. 1;

FIG. 3 is an elevation view of the locking system in the locked position in a first embodiment of the invention;

FIG. 4 is an elevation view of a plate forming part of the locking system of the invention;

FIG. 5 is an elevation view of a latch forming part of the locking system;

FIG. 6 is an elevation view of a control member forming part of the locking system;

FIG. 7 is a section view on line VII-VII of the control member shown in FIG. 6;

FIG. 8 is an elevation view of the locking system in accordance with the invention in an intermediate position;

FIG. 9 is an elevation view of the locking system of the invention, in an unlocked position; and

FIG. 10 is an elevation view of the locking system in the locked position, in a second embodiment of the invention.

### MORE DETAILED DESCRIPTION

In the various figures, the same references are used to designate elements that are identical or similar.

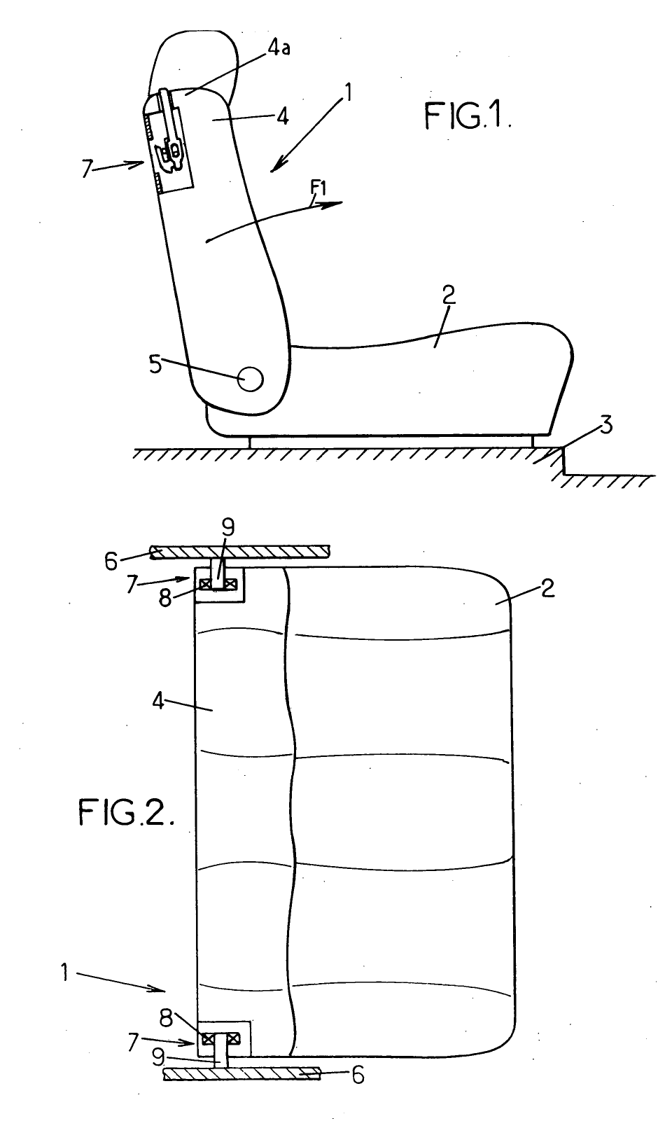

FIG. 1 shows a motor vehicle seat, and in particular a back seat, comprising firstly a seat proper fixed to the structure or floor 3 of the vehicle, and secondly a seat back 4 pivotally mounted relative to the seat proper 2 and thus relative to the structure 3 of the vehicle about a pivot axis 5. The seat back 4 is mounted to pivot about the pivot axis 5 between a raised, in-use position as shown in FIG. 1 in which the seat back 4 extends substantially vertically, and a folded-down position, e.g. in a forward direction as shown by arrow F1, in which the seat back 4 extends substantially horizontally, parallel to the seat proper 2.

In this raised, in-use position, the top portion 4a of the seat back 4 is locked to the structure or bodywork 6 of the vehicle, as shown in FIG. 2, by means of two locking systems 7 disposed transversely on either side of the seat back 4 and designed to connect the rigid structure of the seat back 4 to the structure 6 of the vehicle. The main function of such locking systems 7 is to retain the seat back 4 reliably relative to the structure 6 of the vehicle by preventing any accidental unlocking in the event of said seat back being in its raised, in-use position, while also allowing each locking system 7 to be unlocked simply whenever the user seeks to move the seat back 4 into its folded-down position.

In the example shown in FIG. 2, each locking system 7 comprises a locking device 8 directly fitted to the rigid structure (not shown) of the seat back 4, and an anchor member 9 directly fixed to the bodywork 6 of the motor vehicle. Naturally, it would also be possible to have the locking device 8 fitted to the bodywork 6 of the vehicle while the anchor member 9 is fixed directly to the rigid structure of the seat back 4 of the seat 1.

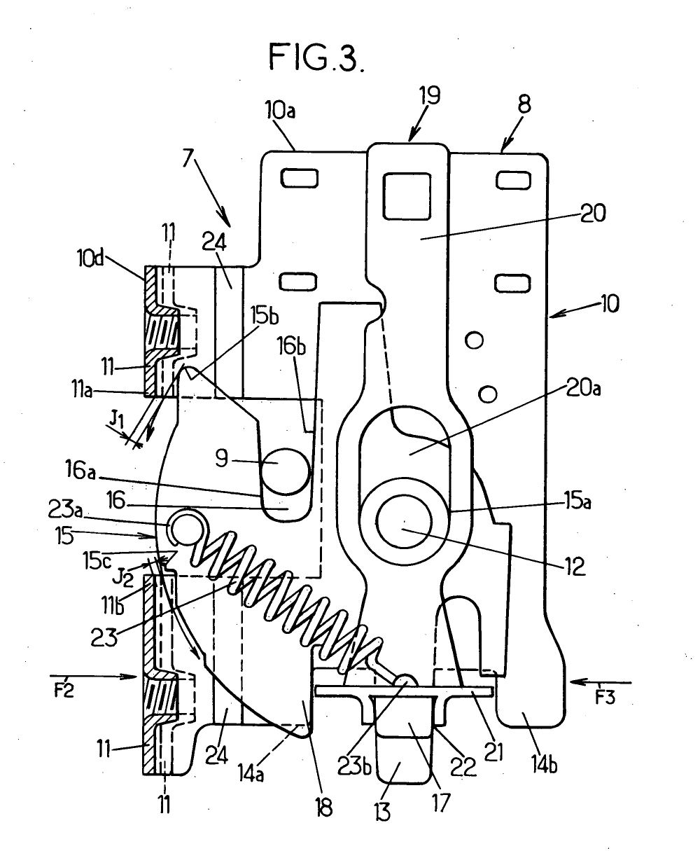

FIG. 3 shows one of the locking systems 7 in a locked state, i.e. when the locking device 8 secured to the seat back 4 is locked on the anchor member 9 fixed to the bodywork 6 of the vehicle. By way of example, the anchor member 9 may be in the form of an anchor peg having one of its ends fixed to the bodywork 6 of the vehicle.

As can be seen in greater detail in FIGS. 3 to 7, the locking device 8 fitted to the rigid structure of the seat back 4 comprises:

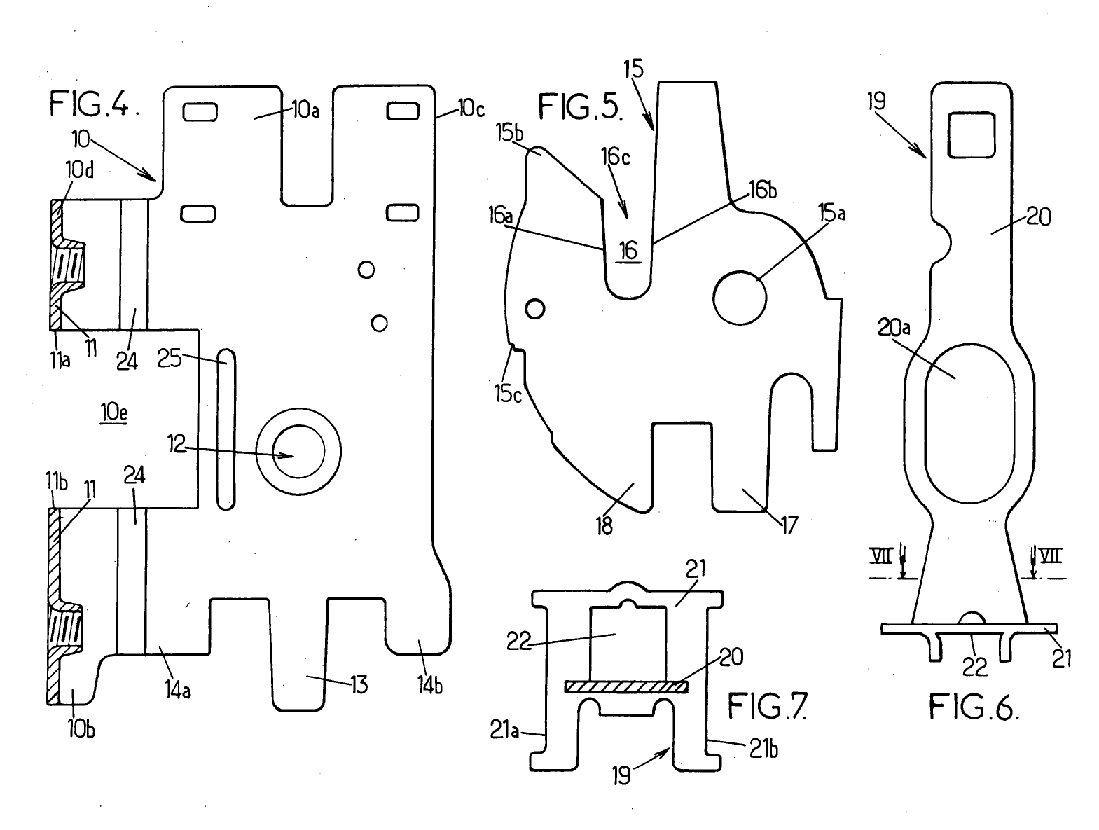

a plate 10 (shown in detail in FIG. 4) in the form of a metal plate that extends vertically between a top portion 10a and a bottom portion 10b; this plate 10 also includes, in its middle portion, a cylindrical pin 12, and in its bottom portion 10b a finger 13 which extends downwards, together with first and second projecting portions 14a and 14b disposed longitudinally on either side of the finger 13; the plate also extends longitudinally between a first longitudinal edge 10c and a second longitudinal edge 10d in which there is made a recess 10e, the second edge 10d also being extended perpendicularly by two flanges 11 for fixing to the rigid structure of the seat back 4, the two flanges 11 possessing ends 11a, 11b disposed facing each other; the plate 10 is also provided with deformable zones 24 performing a function that is described in greater detail below in the description;

a latch 15 (shown in detail in FIG. 5) directly mounted to pivot on the plate 10 by means of a through hole 15a which surrounds the cylindrical pin 12 of the plate 10; this latch 15 includes a notch 16 which is defined by a first side edge 16a, and by a second side edge 16b which extends beyond the opening 16c of the notch 16 to co-operate by coming into contact with the anchor peg 9 as described below, the latch 15 further comprising, in its bottom portion, a finger 17 and a projecting portion 18; furthermore, the latch 15 also includes a wedge portion 15b and a shoulder 15c which are separated from each other by a circularly-arcuate portion for being centered relative to the pin 12 of the plate when the latch is fitted thereto; the wedge portion 15b and the shoulder 15c are designed to pass with respective clearances J1 and J2 (FIG. 3) between the ends 11a, 11b of the plate 10 when the latch pivots from its locked position towards its unlocked position; and

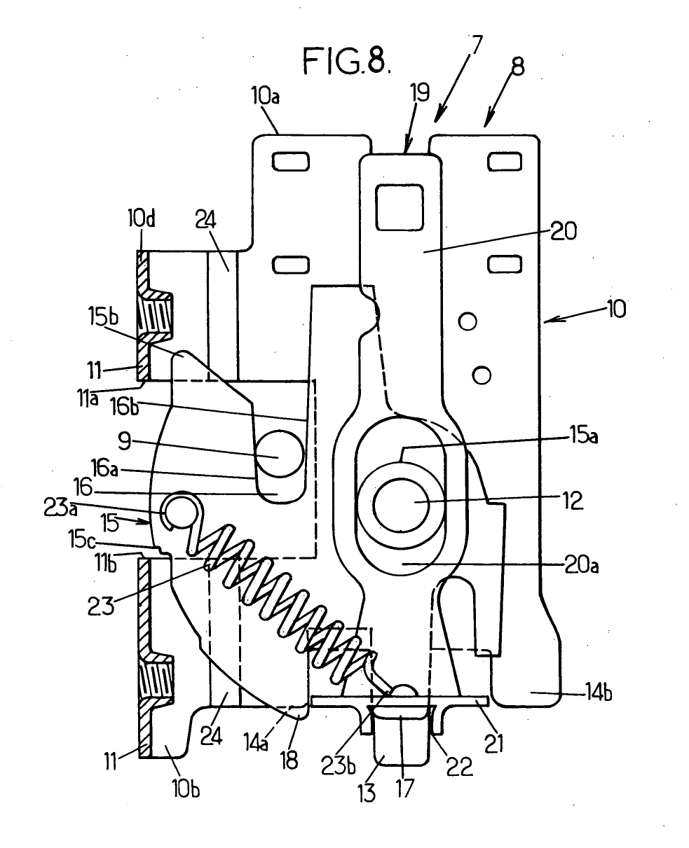

control means formed in the example described herein by a control member 19 (shown in detail in FIGS. 6 and 7) that can be actuated by a user and that comprises a first flange 20 which extends vertically and substantially parallel to the plate 10, and a second flange 21 which extends perpendicularly to the first flange 20; the first flange 20 includes a window 20a of substantially oblong shape for fitting around the cylindrical pin 12 of the plate 10 so that the control member 19 can be actuated by a user to move in a rectilinear direction which, in the example described herein, coincides with the vertical direction; furthermore, the second flange 21 includes a housing 22 for continuously receiving the finger 13 of the plate 10, and also for receiving the finger 17 of the latch 15 when the latch is in the locked position as shown in FIG. 1; furthermore, the second flange 21 is defined longitudinally by a first end 21a and by a second end 21b for placing in register with and in the vicinity of the first and second projecting portions 14a and 14b respectively of the plate 10 when the locking system 7 is in the locked position as shown in FIG. 3.

With the various component elements of the locking device 8 of the locking system 7 described above with reference to FIGS. 3 to 7, the operating principle of the locking system 7 as a whole is described below with reference to FIGS. 3, 8, and 9.

FIG. 3 shows the locking system 7 in the locked state, i.e. when the seat back 4 is in it raised, in-use position (see FIG. 1). In this locked state, the anchor peg 9 fixed to the bodywork 6 of the vehicle is received directly in the notch 16 of the latch 15, and the same latch 15 is prevented from pivoting by means of the control member 19 and the plate 10. More precisely, as can be seen in FIG. 3, in this locked state, the control member 19 is in its high position such that the finger 13 of the plate 10 and the finger 17 of the latch 15 are both received directly in the housing 22 of the flange 21 of the control member 19. Furthermore, the edge 21a of the flange 21 of the control member 19 is placed facing and close to the first projecting portion 14a of the plate 10 and the projecting portion 18 of the latch 15, while the second end 21b of the same flange 21 of the control member 19 is located in register with and in the vicinity of the projecting portion 14b of the plate 10.

Thus, when the seat back 4 is subjected to a rear impact, for example, as symbolized by arrow F2 (FIG. 3), and when the impact is of moderate or small magnitude during normal use of the seat back, where such a rear impact may be caused, for example, by baggage or any other object disposed behind the seat back 4 being propelled towards the seat back 4 due to the vehicle breaking, the anchor peg 9 tends to cause the latch 15 to pivot counterclockwise. The projecting portion 18 and the finger 17 of the latch 15 then come into abutment contact respectively against the side edge 21a and the housing 22 of the control member 19 which in turn reacts by coming into abutment contact against the finger 13 and the second projecting portion 14b of the plate 10. Similarly, when the seat back 4 is subjected to a front impact as symbolized by arrow F3 (see FIG. 3), as may be caused the inertia of an occupant of the rear seat 1 following a rear impact on the vehicle, the anchor peg 9 tends to cause the latch 15 to pivot clockwise so that the finger 17 of said latch 15 comes into abutment contact against the housing 22 of the control member 19 so that the first edge 21a of the second flange 21 of said control member 19 reacts by abutment contact against the projecting portion 14a of the plate 10.

When a user desires to fold down the seat back 4 of the rear seat 1 in a forward direction, the user unlocks the locking system 7 manually.

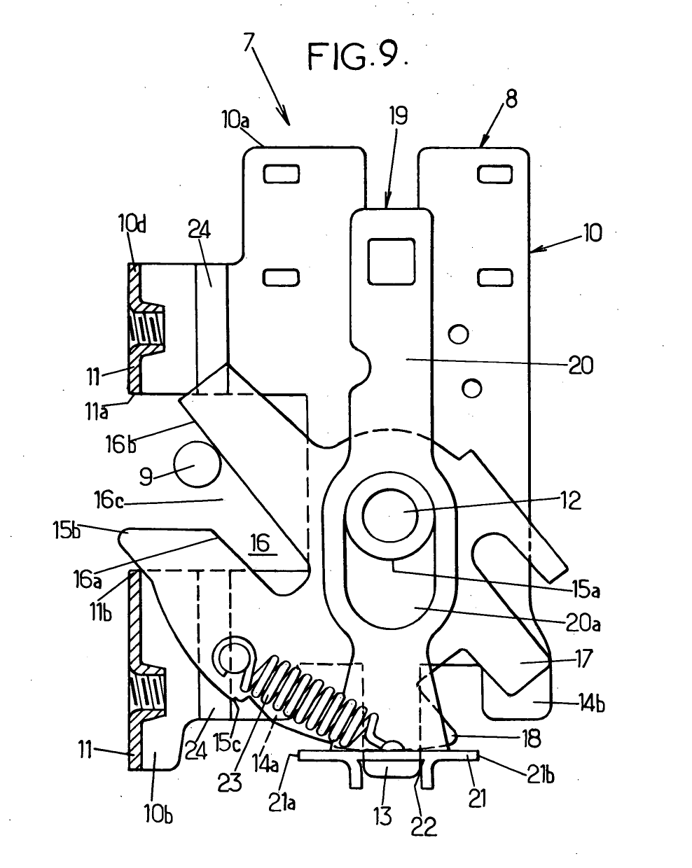

To do this, the user acts directly on the control member 19, pushing it downwards in a rectilinear direction as shown in FIG. 8, which shows the locking system 7 in a position intermediate between its locked position (FIG. 3) and its unlocked position (FIG. 9). When the user acts downwards on the control member 19, the oblong window 20a of the first flange 20 slides on the cylindrical pin of the plate 10 while the housing 22 of the second flange 21 of the control member 19 also moves downwards. The locking member includes an elastically deformable element 23 which may likewise be in the form of a compression spring connecting the control member 19 to the latch 15. More precisely, this compression spring 23 extends between a first end 23a fixed directly to the latch 15 and a second end 23b fixed to the second flange 21 of the control member 19. This compression spring 23 is advantageously disposed diagonally relative to the vertical so that the change in its length between its two ends 23a and 23b is less than the distance traveled by the control member 19. This compression spring 23 is tensioned as the control member 19 is moved downwards.

As can be seen in FIG. 9, when the user continues to move the control member 19 downwards, the finger 17 of the latch 15 and its projecting portion 18 disengage respectively from the housing 22 and from the edge 21a of the second flange 21 of said control member 19. In this configuration, the latch 15 is merely held in position as shown in FIG. 8 by abutment contact between the side edge 16b of the notch 16 and the anchor peg 9. The user then need only cause the seat back 4 to pivot forwards so that as the seat back 4 pivots about its pivot axis 5, and the latch 15 pivots about the pin 12 under drive from the spring 23. As the latch 15 pivots, the wedge portion 15b and the shoulder 16c pass with respective clearances J1 and J2 (FIG. 3) relative to the ends 11a and 11b of the flanges 11 of the plate 1. When the latch 15, or more precisely its wedge portion 15b, comes into abutment contact against the end 11b of the flange 11 of the plate 10, the latch 15 is prevented from turning, while the compression spring 23 holds the control member 19 in the unlocking position as shown in FIG. 9. In this configuration, the finger 13 of the plate 10 remains received in the housing 22 of the second flange 21 of the control member 19 so that the control member 19 cannot pivot.

Conversely, when the user returns the seat back 4 into its raised, in-use position, the user begins by pivoting the seat back 4 rearwards so that the side edge 16b of the notch 16 comes into contact with the anchor peg 9 that is secured to the bodywork 6 of the vehicle. In this configuration, the locking system 7 is in a position as shown in FIG. 9. When the user continues to cause the seat back 4 to pivot rearwards, the anchor peg 9 causes the latch 15 to pivot clockwise, thus putting the compression spring 23 under tension progressively. When the finger 17 of the latch 15 comes into register with the housing 22 of the control member 19, the compression spring 23 then returns the control member 19 upwards so that its housing 22 engages around the finger 17 of the latch 15, thereby returning the entire locking system into a position as shown in FIG. 3, thus causing the locking system 7 as a whole to lock automatically.

In this locked position of the locking system 17, it is important that in the event of a violent rear impact (arrow F2; FIG. 3), turning of the latch 15 should be prevented so as to avoid any accidental unlocking, even if the control member 19 is actuated.

To this end, and as can be seen in FIG. 3, when the seat back is subjected to a violent rear impact, the deformable zones 24 of the plate 10 are adapted to deform, thus causing the ends 11a, 11b of the flanges 11 of the plate to move respectively towards the wedge-shaped portion 15b and the shoulder 15c of the latch 15 (as shown in dashed lines in FIG. 3). This movement of the ends 11a, 11b of the flanges 11 of the plate is at least as great as the clearances J1 and J2 that exist when the seat back is in normal use. Thus, even in the event of the latch 15 pivoting during a rear impact, the wedge portion 15b and the shoulder 15c of the latch will automatically come into abutment contact against the ends 11a, 11b of the flanges, so that the latch 15 cannot pivot towards its unlocked position. Since the anchor peg 9 is still received in the notch 16, the seat back can under no circumstances fold down onto the passenger. In the embodiment shown in FIG. 3, the deformable zones 24 may be formed by a zone of the plate that is of smaller thickness than the remainder of the plate. These deformable zones 24 may also be made by a plurality of holes for weakening the strength of the plate in said predetermined zones. Furthermore, in this embodiment, the deformable zones 24 are situated between the two flanges 11 of the plate and the anchor peg 9, when the latch is in the locked position.

In a variant embodiment, or in addition to the deformable zones 24, the plate 10 may also present (see FIG. 4) a deformable zone formed by a through opening 25 extending substantially vertically and situated between the recess 10e and the cylindrical pin 12 on which the latch is designed to be pivotally mounted.

In the event of a violent rear impact, this through opening 25 is also adapted, by deformation, to enable the cylindrical pin 12 and the flanges 11 to move towards one another. Thus, after deforming, the through opening can cause the latch 15, or more exactly the wedge portion 15b and the shoulder 15c, to come into abutment against the ends 11a, 11b of the flanges, thereby preventing the latch 15 from pivoting from its unlocked position.

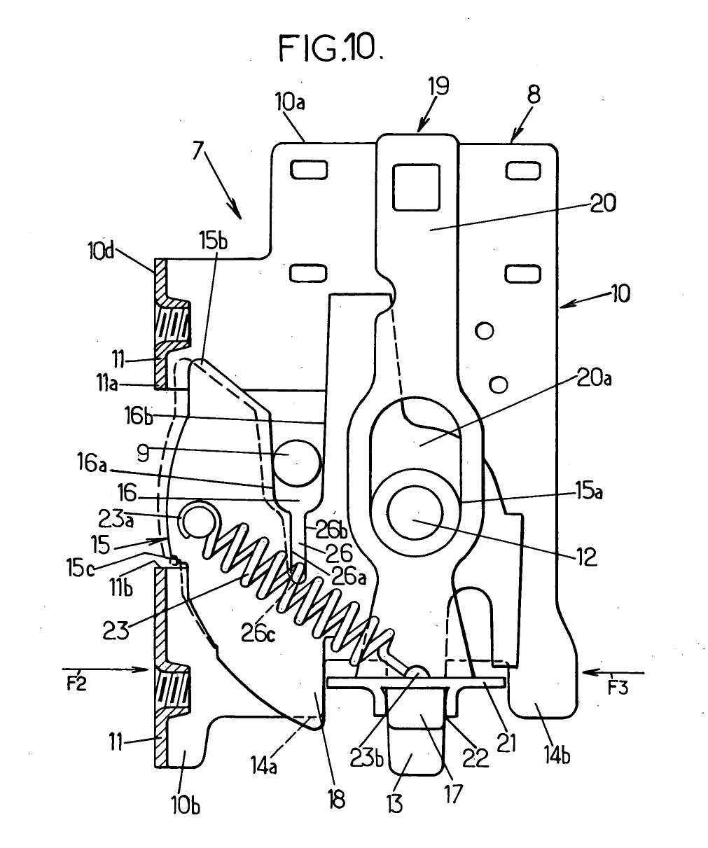

In another embodiment shown in FIG. 10, said at least one deformable zone is no longer implemented in the plate 10 but directly in the latch 15. This deformable zone is in the form of a slot 26 having two edges 26a and 26b which form respective extensions to the edges 16a, 16b of the notch 16. This slot 26 is of a width that is smaller than the width of the notch 16. Furthermore, the edges 16a and 16b extend downwards when the latch is in the locked position to a bottom wall 26c which, properly speaking, constitutes the deformable zone of the latch 15.

Thus, when the seat back 4 is subjected to a violent rear impact (arrow F2), the latch 15 deforms in the bottom 26c of the slot 26 under the forces exerted by the anchor peg 9 on the edge 16a of the notch 16. This deformation of the bottom 26c of the slot 26 causes the wedge portion 15b and the shoulder 15c of the latch 15 to move towards the ends 11a, 11b of the flanges 11 through a distance that is not less than the clearances J1 and J2, thereby preventing the latch 15 from pivoting towards its unlocked position.

In the description above, the latch 15 and the control member 19 are fitted to the plate 10. Naturally, the plate 10 can be replaced by a support comprising two mutually symmetrical plates interconnected, e.g. via a single side flange 11, with the control member 19 and the latch 15 then being disposed between the two symmetrical plates 10 so as to reinforce the strength of the locking system 7 as a whole.

What is claimed is:

1. A system for locking a first element with a second element, the locking system comprising:
at least one plate fitted in fixed manner on the first element;
a latch including a notch for co-operating with an anchor member of the second element, the latch being pivotally mounted on the plate about a pivot pin to pivot between a locked position in which the notch co-operates with the anchor member and an unlocked position; and
control means actuatable by a user from a locking position in which said control means hold the latch in the locked position so as to lock together the first and second elements, towards an unlocking position in which said control means enable the latch to pivot about the pivot pin in such a manner as to unlock the first and second elements,
wherein the plate and/or the latch comprises at least one deformable zone adapted to deform following an impact of predetermined magnitude suffered by one of the first and second elements, by causing a portion of the plate to move sufficiently towards a portion of the latch to ensure that said latch portion comes into abutment contact against said plate portion, thereby preventing the latch from pivoting towards the unlocked position.

2. A locking system according to claim 1, in which the plate includes at least one deformable zone situated, when the latch is in the locked position, substantially between the anchor member and a portion for fixing the plate to the first element.

3. A locking system according to claim 1, in which the plate includes at least one deformable zone situated, when said latch is in the locked position, between the anchor member and the pivot pin for the latch.

4. A locking system according to claim 1, in which the latch includes a slot which extends from the bottom of the notch of said latch, said slot being of a width that is narrower than the width of the notch and having a bottom which forms a deformable zone.

5. A locking system according to claim 1, in which the control means comprise a control member actuatable by a user and including a housing, the control member being mounted to be displaceable on the plate in a direction that is substantially rectilinear and perpendicular to the pivot pin of the latch, between firstly a locking position in which a finger of the latch is housed in the housing of said control member to prevent the latch from pivoting while it is in the locked position so as to lock the first element with the second element, and secondly an unlocking position in which said control member is displaced in the rectilinear direction to enable the finger of the latch to be disengaged from the housing of said control member and to enable the latch to pivot about the pivot pin and towards the unlocked position.

6. A locking system according to claim 5, in which the control member which extends substantially vertically presents a window of oblong shape in which the pivot pin of the latch is housed.

7. A system according to claim 5, in which the control member and the latch are connected together by an elastically deformable element adapted firstly to bring the control member into the locking position when the latch is in the locked position in which the anchor member prevents the latch from pivoting, and secondly to bring and hold the latch into the unlocked position when it no longer co-operates with the anchor member.

8. A locking system according to claim 1, in which the notch of the latch presents an edge which extends beyond the opening of said notch to come into co-operation by contact with the locking member of the second element, by causing said latch to pivot from the unlocked position towards the locked position when the first and second elements are moved towards each other.

9. A motor vehicle seat including a seat back designed to be pivotally mounted relative to the structure of the vehicle between a folded-down position and a raised, in-use position in which said seat back is locked to a fixed portion of the vehicle by means of a locking system according to claim 1.
